(19) United States
(12) Patent Application Publication
(10) Pub. No.: US 2024/0317275 A1
(43) Pub. Date: Sep. 26, 2024

(54) VEHICLE CONTROL DEVICE FOR VEHICLE CAPABLE OF AUTONOMOUS DRIVING AND MANUAL DRIVING

(71) Applicants: DENSO CORPORATION, Kariya-city (JP); TOYOTA JIDOSHA KABUSHIKI KAISHA, Toyota-shi (JP)

(72) Inventors: Naru SUGIMOTO, Tokyo (JP); Tadashi OMACHI, Tokyo (JP); Masahiro YOKOI, Tokyo (JP); Koki SUWABE, Toyota-shi (JP); Yuki TEZUKA, Toyota-shi (JP); Chenyu WANG, Toyota-shi (JP)

(21) Appl. No.: 18/733,663

(22) Filed: Jun. 4, 2024

Related U.S. Application Data
(63) Continuation of application No. PCT/JP2022/039632, filed on Oct. 25, 2022.

(30) Foreign Application Priority Data
Dec. 6, 2021 (JP) 2021-197671

(51) Int. Cl. B60W 60/00; B60W 50/14; G06V 20/56

(52) U.S. Cl. CPC B60W 60/005; B60W 50/14; G06V 20/588; B60W 2050/143; B60W 2050/146; B60W 2420/403; B60W 2520/10; B60W 2552/53; B60W 2554/802

(57) ABSTRACT

A vehicle control device for a vehicle capable of autonomous driving and manual driving includes a surroundings information recognition unit configured to acquire, in a direction of travel of the vehicle, left and right lane boundaries of a lane, and recognizes information about surroundings of the vehicle, a notification unit configured to provide a notification of a hands-on request for switching from a hands-off state to a hands-on state, and a control determination unit configured to determine controls for the vehicle according to a result of recognition by the surroundings information recognition unit. The control determination unit is configured to determine the control to continue the hands-off state when the left and right lane boundaries are parallel in the hands-off state, and determine the control to provide a notification of the hands-on request when the left and right lane boundaries are not parallel in the hands-off state.

### CROSS-REFERENCE TO RELATED APPLICATION

This application is a continuation application of International Application No. PCT/JP2022/039632 filed Oct. 25, 2022 which designated the U.S. and claims priority to Japanese Patent Application No. 2021-197671 filed with the Japan Patent Office on Dec. 6, 2021, the contents of each of which are incorporated herein by reference.

### BACKGROUND

### Technical Field

The present disclosure relates to a vehicle control device.

### Related Art

A known technology for a vehicle capable of autonomous driving and manual driving includes detecting, based on map information, that the vehicle is approaching an area where it may be difficult to perform autonomous driving (hereinafter referred to as an area likely to have autonomous driving malfunction) and then providing to a driver of the vehicle a notification to switch from autonomous driving to manual driving. The notification may be assumed to include a hands-on request for switching from a hands-off state, in which the driver has no hands on the steering wheel, to a hands-on state, in which the driver has at least one hand on the steering wheel. Specifically, the areas likely to have autonomous driving malfunction may be assumed to include splitting roads, roads with an increase in the number of lanes, and intersections.

### BRIEF DESCRIPTION OF THE DRAWINGS

In the accompanying drawings:

FIG. 1 is a block diagram of a vehicle control device according to a first embodiment;

FIG. 2 is a flowchart of a process of providing a notification of a hands-on request, which is performed by the vehicle control device;

FIG. 3 is an illustration of an example where left and right lane markers are not parallel, in the case of a splitting road;

FIG. 4 is an illustration of an example where left and right lane markers are not parallel, in the case of a road with an increase in the number of lanes;

FIG. 5 is an illustration of an example where left and right lane markers are not parallel, in the case of an intersection;

FIG. 6 is a flowchart of a hands-off continuation determination process performed by the vehicle control device;

FIG. 7 is an illustration of a subject vehicle and a preceding vehicle in a stationary state in traffic congestion;

FIG. 8 is an illustration of a subject vehicle and a preceding vehicle in a dashed-line traveling state in traffic congestion; and

FIG. 9 is an illustration of a subject vehicle and a preceding vehicle in a state where the preceding vehicle is traveling offset.

### DESCRIPTION OF SPECIFIC EMBODIMENTS

According to the above known technology, as disclosed in WO2012/047743, map information is used to determine the areas likely to have autonomous driving malfunction, which leads to an issue that it is not applicable to vehicles that do not have map information. Even using map information, there is another issue that reconstruction of lanes may prevent a hands-on request from being provided appropriately until the map information is updated.

In view of the foregoing, it is desired to have a vehicle control device capable of recognizing a road to be traveled in a direction of travel of a vehicle and providing a hands-on request properly, whether map information is available.

One aspect of the present disclosure provides a vehicle control device for a vehicle capable of autonomous driving and manual driving. The vehicle control device includes: a surroundings information recognition unit configured to acquire, in a direction of travel of the vehicle, left and right lane boundaries of a lane in which the vehicle is traveling, and recognizes information about surroundings of the vehicle; a notification unit configured to provide a notification of a hands-on request for switching from a hands-off state, in which a driver of the vehicle has no hands on a steering wheel during autonomous driving being performed, to a hands-on state, in which the driver has at least one hand on the steering wheel; and a control determination unit configured to determine controls for the vehicle according to a result of recognition by the surroundings information recognition unit. The control determination unit is configured to determine the control to continue the hands-off state when the left and right lane boundaries acquired by the surroundings information recognition unit are parallel to each other in the hands-off state, and to determine the control to provide a notification of the hands-on request when the left and right lane boundaries are not parallel to each other in the hands-off state.

Here, the term “parallel” is not limited to “parallel” in the strict sense, but may be interpreted as “parallel” in the light of the common general knowledge of a person skilled in the art. In the above configuration, left and right lane boundaries in a direction of travel of the vehicle are acquired by the surroundings information recognition unit. The control determination unit determines the control to continue the hands-off state when the left and right lane boundaries are parallel to each other, and determines the control to provide a notification of the hands-on request when the left and right lane boundaries are not parallel to each other. In a case where the left and right lane markers are parallel, the road to be traveled may extend straight or may be gently curved, and such a road is suitable for autonomous driving in the hands-off state. Cases where the left and right lane markers are not parallel may include a case where the travel lane splits, a case where the number of lanes increases, and a case where the vehicle approaches an intersection. Such cases are not suitable for autonomous driving in the hands-off state.

Even without map information or with map information that is not updated with the latest information, the above configuration allows whether the road in the forward direction to be traveled by the vehicle is a road suitable for autonomous driving to be recognized according to whether the left and right lane boundaries recognized are parallel to each other, and therefore allows the hands-on request to be provided properly in the hands-off state in which autonomous driving is being performed.

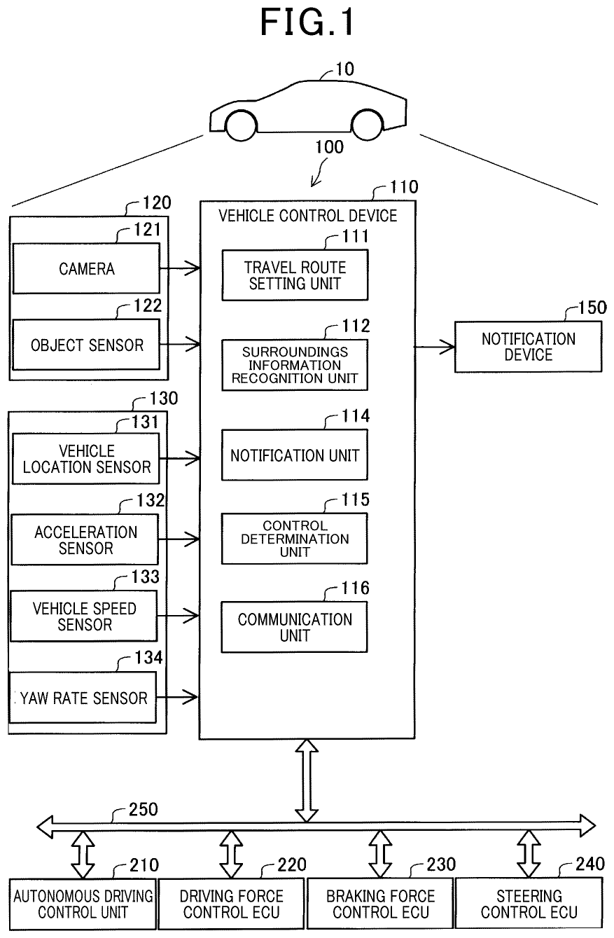

Hereinafter, some embodiments of the disclosure will be described with reference to FIGS. 1 to 9.

### A. First Embodiment

### A1. Configuration of Vehicle Control Device 110

As illustrated in FIG. 1, a vehicle 10 is equipped with an autonomous driving control system 100. The vehicle 10 is capable of autonomous driving and manual driving. In autonomous driving, the vehicle 10 is automatically steered and driven even when the steering wheel for driving the vehicle 10 is not operated by the driver. In some modes of autonomous driving, steering is performed by the driver, and acceleration and deceleration are automatically controlled. In manual driving, the vehicle 10 is steered by the driver operating the steering wheel, and acceleration and deceleration of the vehicle 10 is controlled by the driver.

In the present embodiment, the autonomous driving control system 100 includes a vehicle control device 110, surroundings sensors 120, internal sensors 130, an autonomous driving control unit 210, a driving force control ECU 220, a braking force control ECU 230, and a steering control ECU 240. ECU is an abbreviation for Electronic Control Unit. The vehicle control device 110, the autonomous driving control unit 210, the driving force control ECU 220, the braking force control ECU 230, and the steering control ECU 240 are connected via an on-board network 250.

The surroundings sensors 120 acquire environment information outside the vehicle, which is necessary for autonomous driving. The surroundings sensors 120 include a camera 121 and an object sensor 122. The camera 121 captures and acquires images of surroundings of the vehicle 10, including surroundings in the forward direction of the vehicle 10. The camera 121 may be disposed near the center of the windshield in the vehicle. The camera 121 corresponds to an imaging device. The object sensor 122 detects the surroundings of the vehicle 10. The object sensor 122 may be an object sensor using reflected waves, such as a laser radar, a millimeter wave radar, an ultrasonic sensor or the like.

The internal sensors 130 include a vehicle location sensor 131, an acceleration sensor 132, a vehicle speed sensor 133, and a yaw rate sensor 134. The vehicle location sensor 131 is configured to detect a current location of the vehicle 10. The vehicle location sensor 131 may be a Global Navigation Satellite System(s) (GNSS), a gyro sensor or the like.

The acceleration sensor 132 is configured to detect the acceleration of the vehicle 10. The acceleration sensor 132 may include a longitudinal acceleration sensor configured to detect an acceleration in the longitudinal direction of the vehicle 10 and a lateral acceleration sensor configured to detect an acceleration in the lateral direction of the vehicle 10. The vehicle speed sensor 133 is configured to measure the current travel speed of the vehicle 10. The yaw rate sensor 134 is configured to detect the yaw rate (angular rate of rotation) around the vertical axis through the center of gravity of the vehicle 10. For example, a gyro sensor may be used as the yaw rate sensor 134. The surroundings sensors 120 and the internal sensors 130 transmit various types of data acquired to the vehicle control device 110.

The notification device 150 is configured to notify occupants (mainly the driver) of the vehicle 10 of various information using images and sound. The notification device 150 includes a display device and a speaker. For example, a Head-Up Display (HUD) or a display on the instrument panel may be used as the display device. The images include moving images and text strings.

The vehicle control device 110 includes a travel route setting unit 111, a surroundings information recognition unit 112, a notification unit 114, a control determination unit 115, and a communication unit 116. The vehicle control device 110 is configured as a microcomputer including a central processing unit (CPU), a read-only memory (ROM), a random-access memory (RAM), and an input/output interface (I/O). Functions of these components of the vehicle control device 110 may be implemented by the CPU executing preinstalled programs. In an alternative embodiment, some or all of these components may be implemented by hardware circuits.

The travel route setting unit 111 sets the target travel route to be traveled by the vehicle 10. The target travel route is not simply a route to a location ahead, but includes details of the travel route, such as a travel lane and a travel position within the road.

The surroundings information recognition unit 112 is configured to recognize surroundings information of the vehicle 10 using detection signals from the surroundings sensors 120. More specifically, the surroundings information recognition unit 112 acquires the presence and location information of the left and right lane boundary lines (hereinafter referred to as lane markers) in the direction of travel on the road on which the vehicle is traveling based on the images captured by the camera 121 and output signals of the object sensor 122. Each lane marker may be a white, yellow, or other coloured line. Each lane marker may a solid or dashed line, a single line or composite line. Acquisition of the lane markers may be performed using a known technique. For example, the lane markers may be acquired by detecting luminance of the road surface and lane markers from the image captured by the camera 121 and extracting edges from the image after luminance transformations.

The surroundings information recognition unit 112 is further configured to recognize the presence of traffic signals and their locations and indications, the presence, locations, sizes, distances, and travel directions of other vehicles, the presence of drivers of other vehicles and their actions, the presence and locations of persons around other vehicles, and other information, as surroundings information. The surroundings information recognition unit 112 is further configured to recognize the number of lanes, lane widths, center coordinates of each lane, stop line locations, traffic signal locations, guardrail locations, road grades, road types of curves and straight sections, curvature radii of curves, and lengths of curve sections, etc., as surroundings information. The surroundings information recognition unit 112 may acquire and recognize some or all of these items of information through wireless communications with traffic signals, external servers, etc.

The notification unit 114 is configured to notify the occupants of various items of information, such as the travel route and location information of the vehicle, using the above notification device 150 that is capable of displaying images and outputting voices. The notification unit 114 provides a notification of information about the hands-on request according to the process by the control determination unit 115 depending on the travel condition of the vehicle 10. The hands-on request is a request for switching from the hands-off state, in which the driver has no hands on the steering wheel during autonomous driving, to the hands-on state, in which the driver has at least one hand on the steering wheel.

The control determination unit 115 is configured to determine controls for the vehicle 10 according to the result of recognition by the surroundings information recognition unit 112 and then output the controls for the vehicle 10 to the autonomous driving control unit 210 via the on-board network 250. The communication unit 116 is configured to acquire, for example, traffic information, weather information, accident information, obstacle information, traffic regulation information, etc. from an information center (not shown) via an antenna (not shown). The communication unit 116 may be configured to acquire various items of information from other vehicles via vehicle-to-vehicle communications. The communication unit 116 may be configured to acquire various items of information from roadside equipment installed at various locations on roads via roadside-to-vehicle communications.

The autonomous driving control unit 210 is configured as a microcomputer including a central processing unit (CPU), a random access memory (RAM), a read only memory (ROM), and other components. The autonomous driving function may be implemented by the CPU executing preinstalled programs. The autonomous driving control unit 210 controls the driving force control ECU 220, the braking force control ECU 230, and the steering control ECU 240, to cause the vehicle 10 to travel along the route set by the travel route setting unit 111. The autonomous driving control unit 210 may, for example, provide merging assistance when the vehicle 10 makes a lane change into an adjacent lane, to cause the vehicle 10 to travel along a reference line of the adjacent lane to the lane in which the vehicle 10 is traveling.

The driving force control ECU 220 is an electronic control unit configured to control an actuator that generates vehicle driving forces for the vehicle 10, such as an engine or the like. During manual driving by the driver, the driving force control ECU 220 controls a power source, such as an engine, an electric motor or the like, in response to a depression amount of an accelerator pedal. During autonomous driving, the driving force control ECU 220 controls the power source in response to a requested driving force calculated by the autonomous driving control unit 210.

The braking force control ECU 230 is an electronic control unit configured to control a braking actuator that generates vehicle braking forces for the vehicle 10. During manual driving by the driver, the braking force control ECU 230 controls the braking actuator in response to a depression amount of a brake pedal. During autonomous driving, the braking force control ECU 230 controls the braking actuator in response to a requested braking force calculated by the autonomous driving control unit 210.

The steering control ECU 240 is an electronic control unit configured to control a motor that generates a steering torque. During manual driving by the driver, the steering control ECU 240 controls the motor in response to the operation of the steering wheel to generate an assist torque for the steering operation. This allows the driver to perform the steering operation with a small amount of force, thereby implementing steering of the vehicle 10. During autonomous driving, the steering control ECU 240 controls the motor in response to a requested steering angle calculated by the autonomous driving control unit 210 to perform steering.

### A2. Process Performed by Vehicle Control Device 110

In autonomous driving, the travel route setting unit 111 makes a travel plan of the vehicle 10 up to several seconds later based on the current location detected by the vehicle location sensor 131 and the locations and speeds of other vehicles around the vehicle 10. This travel plan includes a steering plan and an acceleration/deceleration plan, etc. of the vehicle 10 up to several seconds later.

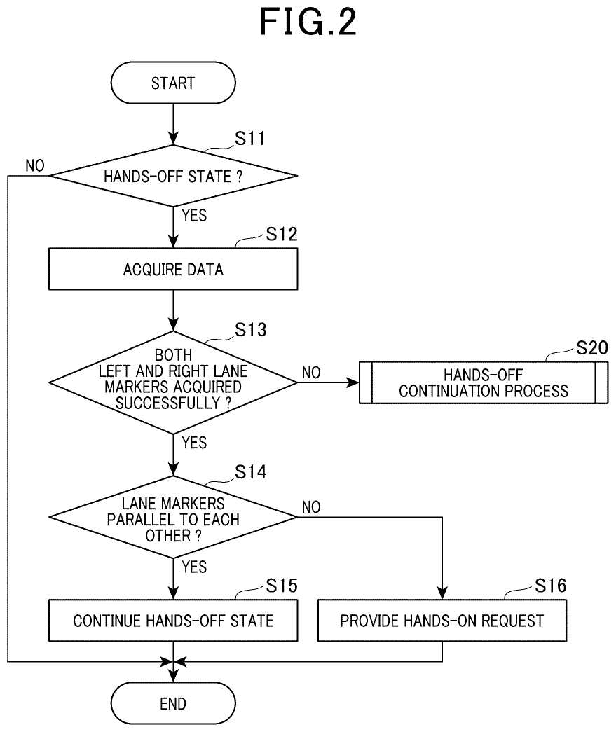

The process illustrated in FIG. 2 is performed repeatedly at predefined time intervals while the vehicle 10 is traveling. As illustrated in FIG. 2, at step S11, it is determined whether the current driving state of the vehicle 10 is the hands-off state. For example, based on a control signal from the autonomous driving control unit 210, it is determined whether the vehicle 10 is in the hands-off state during autonomous driving being performed.

If it is determined at S11 that the vehicle is in the hands-off state (S11: YES), the process flow proceeds to S12. At S12, the surroundings information acquisition unit 112 acquires the presence and location information of the lane markers L1 and L2, which correspond to an extension of the current travel lane of the vehicle 10 and are located on the left and right sides in the direction of travel of the vehicle 10. In the following, “acquisition of the presence and location data of the left and right lane markers L1, L2 in the direction of travel of the vehicle 10” is also referred to simply as “acquisition of the lane markers L1, L2.”

Upon acquisition of the lane markers L1, L2, it is then determined at S13 whether both left and right lane markers L1, L2 have been successfully acquired. If both left and right lane markers L1, L2 have been successfully acquired (S13: YES), the process flow proceeds to S14 to determine whether the left and right lane markers L1, L2 in the direction of travel are parallel to each other. Here, the term “parallel” is not limited to “parallel” in the strict sense, but may be interpreted as “parallel” in the light of the common general knowledge of a person skilled in the art. In addition, the term “in the direction of travel” may be defined as being within a predefined distance ahead of the current location, or may be defined as being within a distance to a location that will be reached several seconds later, as estimated from the current speed of the vehicle.

If the left and right lane markers L1 and L2 are parallel (S14: YES), the process flow proceeds to S15 and the hands-off state is continued. In the case where the left and right lane markers L1 and L2 are parallel, the road to be traveled extends straight or is gently curved, and such a road is suitable for autonomous driving in the hands-off state. In the following, such a road is also referred to as a “road suitable for autonomous driving.” Therefore, in the case where the left and right lane markers L1 and L2 are parallel to each other, as described above, the hands-off state is continued since the road to be traveled can be recognized as being the road suitable for autonomous driving.

On the other hand, if the left and right lane markers L1, L2 are not parallel to each other, that is, non-parallel (S14: NO), the process flow proceeds to S16, where a hands-on request is provided by the notification device 150. Specifically, an image representing the hands-on request may be displayed on a display device, or a sound may be output from a speaker to provide a notification of the hands-on request.

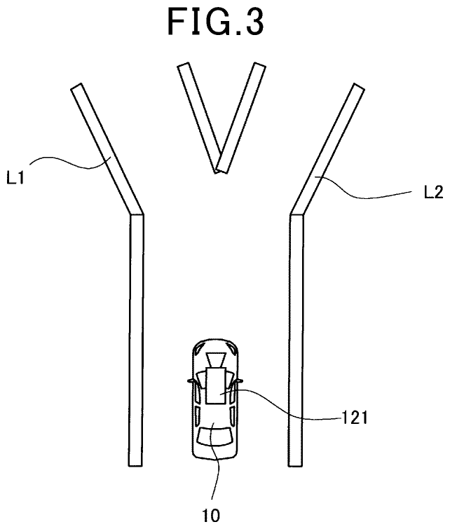

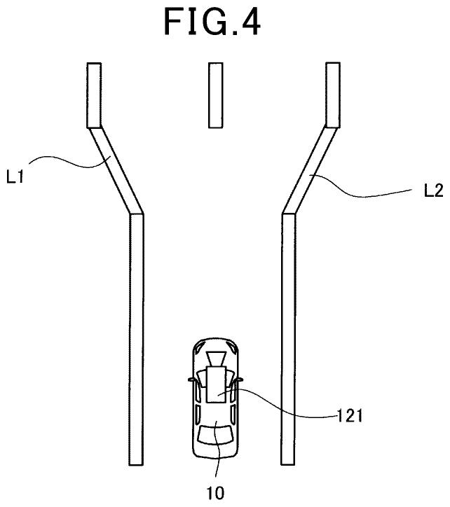

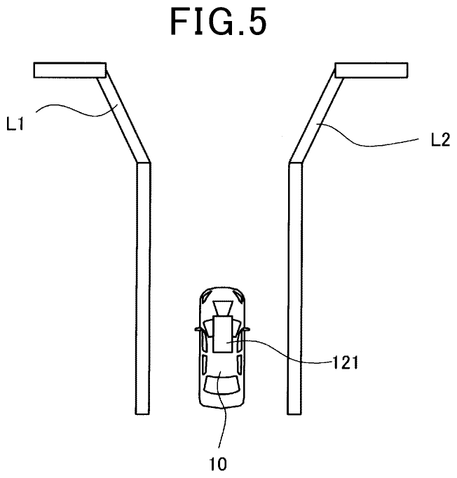

Cases where the left and right lane markers L1 and L2 are not parallel may include a case where the travel lane splits as illustrated in FIG. 3, a case where the number of lanes increases as illustrated in FIG. 4, and a case where the vehicle approaches an intersection as illustrated in FIG. 5. Such splitting roads, roads with an increase in the number of lanes, and intersections require precise handling control and safety check. Thus, it is difficult to apply autonomous driving in the hands-off state to such roads. Therefore, in this control, a hands-on request is provided at S16. Upon completion of the process steps S15 and S16, this routine ends. In the following, roads that are not suitable for autonomous driving, such as splitting roads, roads with an increase in the number of lanes, and intersections, are also referred to as “roads not suitable for autonomous driving.”

If the vehicle 10 is continuously traveling in the lane demarcated by the lane markers L1, L2, both left and right lane markers L1, L2 will basically be acquired normally at S13. However, either or both of the lane markers L1 and L2 may fail to be detected (S13: NO) for some reasons, such as a reason that the lane markers L1 and L2 in the direction of travel are missing during construction, or a reason that the lane markers L1 and L2 are obscured by the presence of a preceding vehicle 11 in the camera's angle of view. In this case, the process flow proceeds to S20, where the hands-off continuation determination process is performed. Cases where either or both of the lane markers L1 and L2 may fail to be detected may include a case where the camera 121 can not capture images of the lane markers L1 and L2 themselves, as well as a case where the camera 121 can capture the lane markers L1 and L2, but the captured area of the lane markers L1 and L2 is too small for the surroundings information recognition unit 112 to accurately recognize the lane markers as the lane markers L1 and L2.

### A3. Details of Hands-Off Continuation Determination Process (at S20)

In the hands-off continuation determination process (S20), the hands-on request is not immediately provided when either or both of the lane markers L1 and L2 fail to be detected, but controls are determined after determining whether to continue the hands-off state according to specific conditions. Even when either or both of the lane markers L1 and L2 temporarily fail be detected, there may be cases where the hands-off state is allowed to be continued. That is, after determining whether the specific conditions (first to third conditions in the present embodiment, described later) intended for such cases are met, either the control to continue the hands-off state or the control to provide the hands-on request is performed. The details of these conditions will now be described with reference to a control flowchart.

### Determination of First Condition

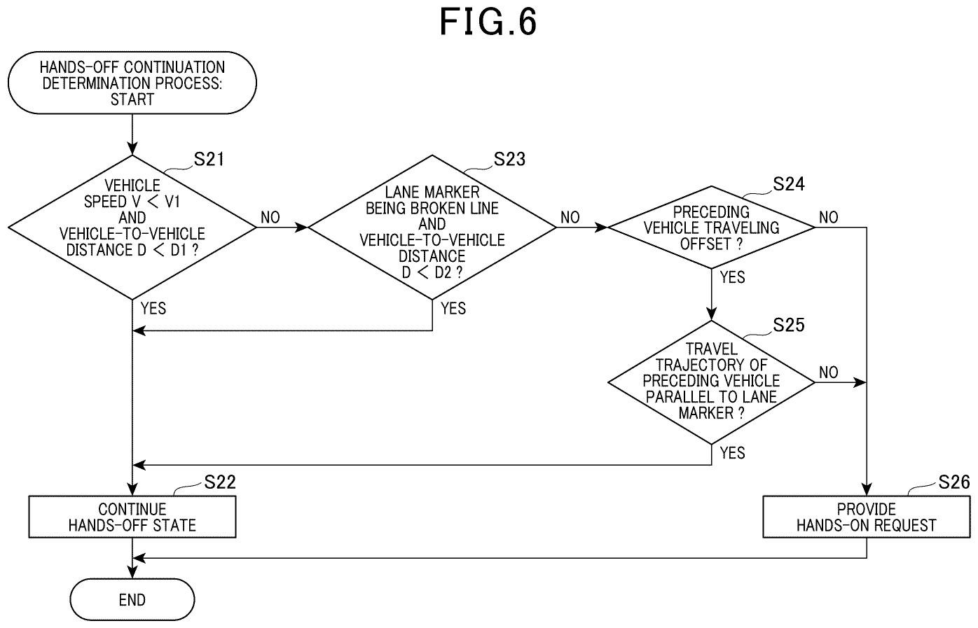

FIG. 6 is a flowchart illustrating the hands-off continuation determination process performed by the vehicle control device 110. As illustrated in FIG. 6, at S21, a determination is made as to whether a first condition is met that the current vehicle speed V of the vehicle 10 is lower than a first speed threshold V1 and a vehicle-to-vehicle distance D between the vehicle 10 and a preceding vehicle 11 is less than a first distance threshold D1. The current vehicle speed V of the vehicle 10 may be acquired from the vehicle speed sensor 133. The vehicle-to-vehicle distance D between the vehicle 10 and the preceding vehicle 11 is acquired by the surroundings information acquisition unit 112 based on data read from the vehicle location sensor 131 and the surroundings sensor 120.

The first speed threshold V1 is considered and set in advance to an upper limit indicating that the vehicle 10 is stationary (V-0) or is traveling at a very low speed, almost equal to zero. When the completely stationary state is used as the criterion for judgment, the first speed threshold V1 may be set to zero. As an example, the first speed threshold V1 is set within a range of zero to about 1 km/h. The first distance threshold D1 is considered and set in advance to an upper limit indicating that the preceding vehicle 11 is very close to the vehicle 10 due to being stuck in traffic congestion or the like as compared to the normal driving case. Specifically, for example, the first distance threshold D1 is set to 3 m or less.

At the process step S21, a state is detected where the preceding vehicle 11 is present and the vehicle 10 is stationary or traveling at a very low speed due to traffic congestion. That is, if the preceding vehicle 11 is present and the vehicle 10 is stationary or traveling at a very low speed due to traffic congestion, the first condition is met (S21: YES). In the following, such a state corresponding to the first condition is also referred to as a “stationary state in traffic congestion”. In other words, at S21, it is determined whether the vehicle 10 is in the stationary state in traffic congestion.

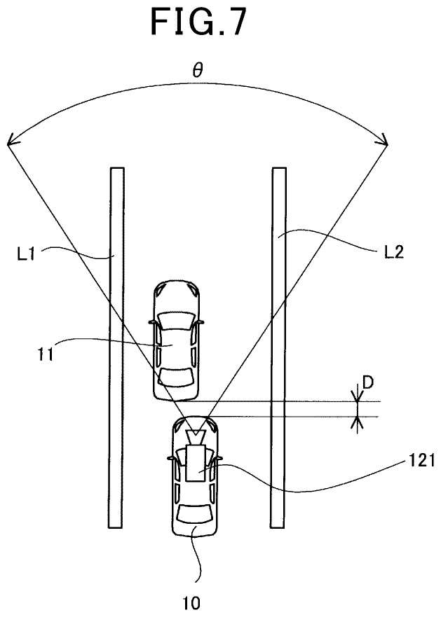

FIG. 7 illustrates the vehicle 10 and the preceding vehicle 11 in the stationary state in traffic congestion. As illustrated in FIG. 7, in the stationary state in traffic congestion, the preceding vehicle 11 is very close ahead of the vehicle 10, covering the entire angle of view θ of the camera. Thus, either or both of the left and right lane markers L1 and L2 may not be detected due to the camera 121 failing to acquire the image of the left and right lane markers L1 and L2. In the example illustrated in FIG. 7, either or both the left and right lane markers L1 and L2 fail to be detected.

If the vehicle 10 is in the stationary state in traffic congestion (S21: YES), the process flow proceeds to S22, where the hands-off state is continued. The reason is as follows. Even when it is not possible to determine whether the lane markers L1 and L2 are parallel because the lane markers L1 and L2 fail to be acquired, there is no need to provide the hands-on request in the stationary state in traffic congestion. The hands-off state should therefore be continued. After completion of the process step S22, the control illustrated in FIG. 2 may be performed after the distance to the preceding vehicle 11 has increased to a predefined distance or more or after the vehicle 10 has traveled a predefined distance or more. For example, after the vehicle 10 has traveled a certain distance, the preceding vehicle is likely to have traveled a similar distance. Then, the situation, such as the vehicle-to-vehicle distance D between the vehicle and the preceding vehicle, is expected to have changed.

### Determination of Second Condition

If the vehicle is not in the stationary state in traffic congestion (S21: NO), the process flow proceeds to S23, where a determination is made as to whether a second condition is met that at least one of the lane markers L1 and L2 is a dashed line and the vehicle-to-vehicle distance D to the preceding vehicle 11 is less than a second distance threshold D2. The second distance threshold D2 is set greater than the first distance threshold D1. Specifically, for example, the second distance threshold D2 is set to 3 m to 5 m.

At the process step S23, a state is detected where at least one of the lane markers L1, L2 is a dashed line and the preceding vehicle 11 is present due to traffic congestion. That is, the state where at least one of the lane markers L1, L2 is a dashed line and the preceding vehicle 11 is present due to traffic congestion means that the second condition is met (S23: YES). In the following, such a state corresponding to the second condition is also referred to as a “dashed-line traveling state in traffic congestion”. In other words, at S23, it is determined whether the vehicle 10 is in the dashed-line traveling state in traffic congestion.

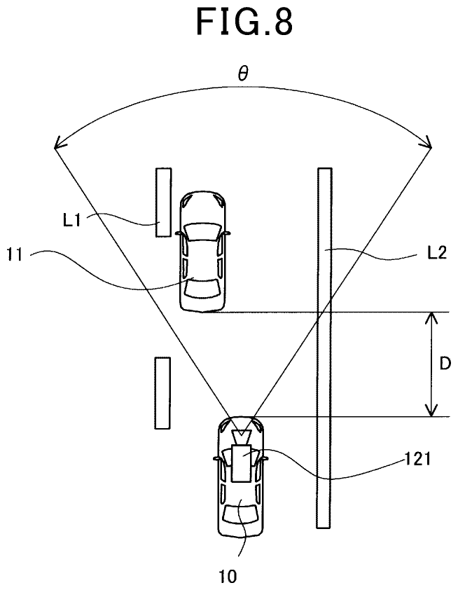

FIG. 8 illustrates the vehicle 10 and the preceding vehicle 11 in the dashed-line traveling state in traffic congestion. As illustrated in FIG. 8, in the dashed-line traveling state in traffic congestion, the vehicle-to-vehicle distance is not as small as in the stationary state in traffic congestion illustrated in FIG. 7, but there is the preceding vehicle 11 near and ahead of the vehicle 10. Thus, either or both of the left and right lane markers L1 and L2 may fail to be detected because the image of the forward dashed line can not be acquired by the camera 121. In the example illustrated in FIG. 8, the left lane marker L1 fails to be detected because the left lane marker L1 is a dashed line and a left side portion of the angle of view θ is obstructed by the preceding vehicle 11.

If the vehicle 10 is in the dashed-line traveling state in traffic congestion (S23: YES), the process flow proceeds to S22, where the hands-off state is continued. The reason is as follows. Even when it is not possible to determine whether the lane markers L1 and L2 are parallel due to the lane markers L1 and L2 failing to be acquired and the first condition is not met, there is no need to provide the hands-on request in the dashed-line traveling state in traffic congestion. The hands-off state should therefore be continued. After completion of the process step S22, the control illustrated in FIG. 2 may be performed after the vehicle 10 has traveled the dashed-line interval.

### Determination of Third Condition

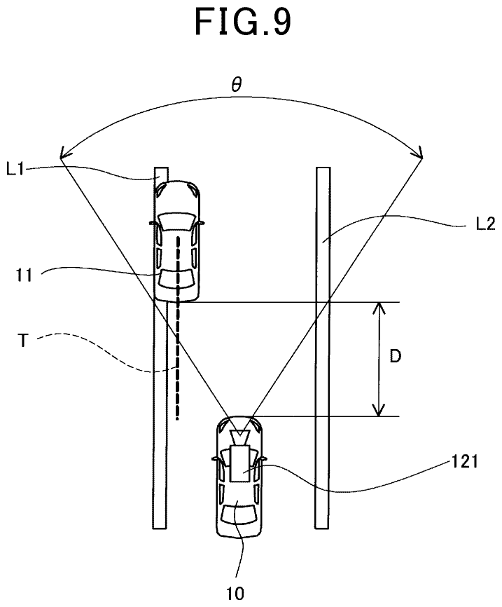

If the vehicle is not in dashed line traveling state in traffic congestion (S23: NO), the process flow proceeds to S24, where it is determined whether the preceding vehicle 11 is traveling offset. At steps S24 and S25, it is determined whether the third condition is met. FIG. 9 illustrates the vehicle 10 and the preceding vehicle 11 when the preceding vehicle 11 is traveling offset. As illustrated in FIG. 9, traveling offset means traveling such that the vehicle body does not fit within the lane and the vehicle body is on one of the lane markers, e.g., L1.

Whether the preceding vehicle 11 is traveling offset is recognized by the surroundings information recognition unit 112 based on data read from the vehicle location sensor 131 and the surroundings sensor 120. More specifically, first, the lane width is estimated from the left and right lane markers L1 and L2 in the immediately previous cycle. When the preceding vehicle 11 starts traveling offset and obscures at least one of the lane markers L1, L2, the visible area of the lane becomes narrower when the location information of the preceding vehicle 11, vehicle-to-vehicle distance, and angle of view are monitored in chronological order. The traveling-with-offset of the preceding vehicle 11 may thus be estimated by detecting this change.

In the present embodiment, FIG. 9 illustrates an example in which one lane marker L1 (the left lane marker in FIG. 9) is obscured by one preceding vehicle 11 traveling offset. As illustrated in FIG. 9, even when the vehicle-to-vehicle distance is greater than in the dashed-line traveling state in traffic congestion illustrated in FIG. 8, when the preceding vehicle 11 continues traveling offset for a certain time, either or both of the left and right lane markers L1 and L2 may fail to be detected because the camera 121 fails to capture enough images of the forward lane markers L1 and L2.

If the preceding vehicle 11 is traveling offset (S24: YES), the process flow proceeds to S25, where a determination as to whether the travel trajectory T of the preceding vehicle 11 and the lane marker L2 are parallel is made. At the parallelism determination step at S25, a determination as to whether the left and right lane boundaries are parallel is made after the travel trajectory T of the preceding vehicle 11 is applied as an alternative indicator to the lane marker L1. In the example illustrated in FIG. 9, a determination is made as to whether the travel trajectory T of the preceding vehicle 11 and the right lane marker L2 are parallel. The travel trajectory T of the preceding vehicle 11 is calculated by measuring by the camera 121 and storing locations of the preceding vehicle 11, and connecting the stored data of locations of the preceding vehicle 11 in chronological order.

If the travel trajectory T of the preceding vehicle 11 and the lane marker L2 are parallel (S25: YES), the process flow proceeds to step 22, where the hands-off state is continued. Here, the state where the preceding vehicle 11 is traveling offset and the travel trajectory T of the preceding vehicle 11 and the lane marker L2 are parallel means that the third condition is met. In the following, such a state that the third condition is met is also referred to as a “state of the preceding vehicle being traveling offset”.

Even if the parallelism determination fails to be made due to the lane markers L1 and L2 failing to be acquired and the first and second conditions are thus not met, but the third condition is met, it may be presumed that the lane markers L1 and L2 are parallel and the road suitable for autonomous driving will continue for a certain section of the road. In such a case, there is no need to provide the hands-on request, and it is better to continue the hands-off state. Therefore, the hands-off state is continued at S22.

If it is determined at S24 that the preceding vehicle 11 is not traveling offset (S24: NO), or if it is determined at S25 that the travel trajectory T of the preceding vehicle 11 and the lane marker L2 are not parallel (S25: NO), the processing flow proceeds to S26, where the hands-on request is provided. After completion of step S22 or S26, this routine ends. In the above flowchart, the process steps from S21 to S25 correspond to a process of determining whether to continue the hands-off state.

### Advantages

(1) According to the vehicle control device 110 of the first embodiment, the left and right lane markers L1, L2 in the direction of travel of the vehicle 10 are acquired by the surroundings information acquisition unit 112 based on various items of data detected by the surroundings sensor 120 and the internal sensor 130. This allows the control determination unit 115 to recognize the shape of the road on which the vehicle 10 is traveling based on whether the left and right lane markers L1, L2 are parallel, thus allowing a determination as to whether to continue the hands-off state to be made.

That is, even without map information or with map information that is not updated with the latest information, it is possible to recognize whether the road in the forward direction to be actually traveled by the vehicle 10 is a road suitable for autonomous driving. In addition, in the hands-off state in which autonomous driving is being performed, the hands-on request can be provided properly according to information about the recognized road being traveled.

(2) In the vehicle control device 110 of the first embodiment described above, the hands-off continuation determination process (at S20) is performed when at least one of the left and right lane markers L1, L2 fail to be acquired at S13. When a determination as to whether the left and right lane markers L1 and L2 are parallel fails to be made due to at least one of the left and right lane markers L1 and L2 failing to be acquired, it is basically impossible to recognize the road to be traveled in the forward direction of travel. Thus, the hands-on request should be provided to cease autonomous driving. Nevertheless, even when a determination as to whether the left and right lane markers L1 and L2 are parallel fails to be made due to at least one of the left and right lane markers L1 and L2 failing to be acquired, there is no need to provide the hands-on request when any of the first to third conditions is met. The first condition is that the vehicle is in the stationary state in traffic congestion, the second condition is that the vehicle is in the low-speed traveling state in traffic congestion, and the third condition is that the vehicle is in the state of the preceding vehicle being traveling offset.

In the vehicle control device 110 of the first embodiment described above, the hands-off continuation determination process (at S20) is performed. Therefore, instead of immediately providing the hands-on request when at least one of the lane markers L1 and L2 fails to be detected, the controls may be determined after determining whether to continue the hands-off state according to the specific conditions. This can therefore prevent unnecessary hands-on requests from being provided frequently and improve the user's convenience.

(3) There are several possible situations where the hands-on request is provided unnecessarily. Among these situations, the situation where the vehicle is stationary in traffic congestion (the first condition) and the situation where the vehicle is traveling at low speed in traffic congestion (the second condition) occur more frequently. Therefore, checking such frequent conditions can effectively prevent the hands-on request from being provided excessively frequently.

(4) Furthermore, in the above first embodiment, the control process efficiency can be improved because the first to third conditions are checked in order of decreasing frequency at which the hands-on request is provided unnecessarily.

(5) In the vehicle control device 110 of the above first embodiment, the lane markers L1 and L2 are recognized using images captured by the camera 121 mounted to the vehicle 10. Therefore, as compared to a configuration in which, for example, information detected by the preceding vehicle 11 is acquired via a network, road information in real time can be acquired more accurately.

### B. Other Embodiments

(B1) In the first embodiment above, the lane markers L1 and L2 are acquired as lane boundaries. Alternatively, in cases where there are no lane markers L1 and L2, other types of lane boundaries such as shoulders, roadside drains, guardrails, and curbs may also be used to make the parallelism determination.

(B2) In the above first embodiment, an example of determining the second condition has been described, where the left lane marker L2 is a dashed line as illustrated in FIG. 8. Alternatively, the right lane marker L1 may be a dashed line, or both the lane markers L1 and L2 may be dashed lines. In such cases, the second condition may be determined in the similar manner.

(B3) In the above first embodiment, an example of determining the third condition has been described, where the preceding vehicle 11 is traveling offset to one side. Alternatively, as another example, there may be a plurality of lanes and the left and right lane markers L1 and L2 of one of the plurality of lanes may be obscured by two preceding vehicles 11 traveling offset to the same side. In such a case, the third condition may be determined in the similar manner. In this case, at S25, a parallelism determination may be made as to whether the travel trajectories of the two preceding vehicles 11 are parallel.

(B4) In the above first embodiment, the first to third conditions are determined in this order, but the order is not limited to this order. The second or third condition may be determined first, or each of the first to third conditions may be determined independently without being determined consecutively.

Alternatively, at least one of the first to third conditions may be omitted. The vehicle control device 110 and the method thereof described in the present disclosure may be realized by a dedicated computer provided by configuring a processor and memory programmed to perform one or more functions embodied in a computer program. Alternatively, the vehicle control device 110 and the method thereof described in the present disclosure may be realized by a dedicated computer provided by configuring a processor with one or more dedicated hardware logic circuits. Alternatively, the vehicle control device 110 and the method thereof described in the present disclosure may be realized by one or more dedicated computers configured by a combination of a processor and memory programmed to perform one or more functions, and a processor configured with one or more hardware logic circuits. In addition, the computer program may be stored in a computer-readable, non-transitory tangible storage medium as instructions to be executed by a computer.

What is claimed is:

1. A vehicle control device for a vehicle capable of autonomous driving and manual driving, comprising:
a surroundings information recognition unit configured to acquire, in a direction of travel of the vehicle, left and right lane boundaries of a lane in which the vehicle is traveling, and recognizes information about surroundings of the vehicle;
a notification unit configured to provide a notification of a hands-on request for switching from a hands-off state, in which a driver of the vehicle has no hands on a steering wheel during autonomous driving being performed, to a hands-on state, in which the driver has at least one hand on the steering wheel; and
a control determination unit configured to determine controls for the vehicle according to a result of recognition by the surroundings information recognition unit, wherein
the control determination unit is configured to determine the control to continue the hands-off state when the left and right lane boundaries acquired by the surroundings information recognition unit are parallel to each other in the hands-off state, and to determine the control to provide the notification of the hands-on request when the left and right lane boundaries are not parallel to each other in the hands-off state,
the control determination unit is configured to determine whether to continue the hands-off state when at least one of the lane boundaries fails to be recognized by the surroundings information recognition unit, and then perform a hands-off continuation determination process to determine either the control to continue the hands-off state or the control to provide the notification of the hands-on request, and
the control determination unit is configured to, in the hands-off continuation determination process, determine the control to continue the hands-off state when a speed of the vehicle is lower than a predefined first speed threshold and a vehicle-to-vehicle distance from the vehicle to a preceding vehicle is less than a predefined first distance threshold.

2. The vehicle control device according to claim 1, further comprising an imaging device configured to capture images of surroundings ahead of the vehicle,
the surroundings information recognition unit is configured to acquire the lane boundaries from the images captured by the imaging device.

3. A vehicle control device for a vehicle capable of autonomous driving and manual driving, comprising:
a surroundings information recognition unit configured to acquire, in a direction of travel of the vehicle, left and right lane boundaries of a lane in which the vehicle is traveling, and recognizes information about surroundings of the vehicle;
a notification unit configured to provide a notification of a hands-on request for switching from a hands-off state, in which a driver of the vehicle has no hands on a steering wheel during autonomous driving being performed, to a hands-on state, in which the driver has at least one hand on the steering wheel; and
a control determination unit configured to determine controls for the vehicle according to a result of recognition by the surroundings information recognition unit, wherein
the control determination unit is configured to determine the control to continue the hands-off state when the left and right lane boundaries acquired by the surroundings information recognition unit are parallel to each other in the hands-off state, and determine the control to provide the notification of the hands-on request when the left and right lane boundaries are not parallel to each other in the hands-off state,
the control determination unit is configured to determine whether to continue the hands-off state when at least one of the lane boundaries fails to be recognized by the surroundings information recognition unit, and then perform a hands-off continuation determination process to determine either the control to continue the hands-off state or the control to provide the notification of the hands-on request, and
the control determination unit is configured to, in the hands-off continuation determination process, determine the control to continue the hands-off state when at least one of the lane boundaries is recognized by the surroundings information recognition unit as being a dashed line and the vehicle-to-vehicle distance from the vehicle to a preceding vehicle is less than a predefined second distance threshold.

4. The vehicle control device according to claim 3, further comprising an imaging device configured to capture images of surroundings ahead of the vehicle,
the surroundings information recognition unit is configured to acquire the lane boundaries from the images captured by the imaging device.

5. A vehicle control device for a vehicle capable of autonomous driving and manual driving, comprising:
a surroundings information recognition unit configured to acquire, in a direction of travel of the vehicle, left and right lane boundaries of a lane in which the vehicle is traveling, and recognizes information about surroundings of the vehicle;
a notification unit configured to provide a notification of a hands-on request for switching from a hands-off state, in which a driver of the vehicle has no hands on a steering wheel during autonomous driving being performed, to a hands-on state, in which the driver has at least one hand on the steering wheel; and
a control determination unit configured to determine controls for the vehicle according to a result of recognition by the surroundings information recognition unit, wherein
the control determination unit is configured to determine the control to continue the hands-off state when the left and right lane boundaries acquired by the surroundings information recognition unit are parallel to each other in the hands-off state, and to determine the control to provide a notification of the hands-on request when the left and right lane boundaries are not parallel to each other in the hands-off state,
the control determination unit is configured to determine whether to continue the hands-off state when at least one of the lane boundaries fails to be recognized by the surroundings information recognition unit, and then perform a hands-off continuation determination process to determine either the control to continue the hands-off state or the control to provide the notification of the hands-on request, and
the control determination unit is configured to, in the hands-off continuation determination process, when the surroundings information recognition unit recognizes that one of the lane boundaries is obscured by a preceding vehicle, apply a travel trajectory of the preceding vehicle as an alternative indicator of the one of the lane boundaries obscured by the preceding vehicle, and then determine the control to continue the hands-off state when the travel trajectory of the preceding vehicle and a remaining one of the lane boundaries are parallel to each other.

6. The vehicle control device according to claim 5, further comprising an imaging device configured to capture images of surroundings ahead of the vehicle,
the surroundings information recognition unit is configured to acquire the lane boundaries from the images captured by the imaging device.
